(19) United States
(12) Patent Application Publication
(10) Pub. No.: US 2024/0345345 A1
(43) Pub. Date: Oct. 17, 2024

(54) SYSTEM, APPARATUS, AND METHOD OF LINK TRAINING OVER A REDRIVER-BASED OPTICAL INTERCONNECT

(71) Applicant: Intel Corporation, Santa Clara, CA (US)

(72) Inventor: Debendra Das Sharma, Saratoga, CA (US)

(73) Assignee: Intel Corporation, Santa Clara, CA (US)

(21) Appl. No.: 18/757,571

(22) Filed: Jun. 28, 2024

(51) Int. Cl. G02B 6/42; G02B 6/43

(52) U.S. Cl. CPC G02B 6/4274; G02B 6/43

(57) ABSTRACT

For example, an electronic system may include interconnect circuitry to communicate over an electrical interconnect; and a Physical layer (PHY) controller configured to access a plurality of optical-capability registers to identify optical-training control information and optical-capability information. For example, the optical-training control information may include a start-training bit. For example, based on a determination that the start-training bit is set to a predefined value, the PHY controller may initiate an optical-based link training procedure via the electrical interconnect to train a link between the electronic system and a partner electronic system over a redriver-based optical interconnect. For example, the optical-based link training procedure may be based on the optical-capability information.

### BACKGROUND

Various types of interconnects may be implemented to transfer data between various components, for example, in computer systems and/or communications systems.

An interconnect technology, for example, a Peripheral Component Interconnect Express (PCIe) interconnect technology, a Compute Express Link (CXL) interconnect technology, or the like, may be utilized to support a communication path, e.g., a link, between two devices or components.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a flexible (flex) mapping scheme, which may be implemented for communication via a link over a redriver-based optical interconnect, in accordance with some demonstrative aspects.

FIG. 3 is a schematic illustration of an optical-capability register structure, in accordance with some demonstrative aspects.

FIG. 4 is a schematic illustration of an optical-based link training procedure, in accordance with some demonstrative aspects.

FIG. 5 is a schematic illustration of a configuration state of an optical-based link training procedure, in accordance with some demonstrative aspects.

FIG. 6 is a schematic illustration of a recovery state of an optical-based link training procedure, in accordance with some demonstrative aspects.

FIG. 7 is a schematic flow-chart illustration of a method of link training over a redriver-based optical interconnect, in accordance with some demonstrative aspects.

FIG. 8 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a Personal Computer (PC), a server computer, a User Equipment (UE), a Mobile Device (MD), a desktop computer, a mobile computer, a laptop computer, a notebook computer, a tablet computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication device, a gaming device, a video device, an audio device, an audio-video (A/V) device, and the like.

Some aspects may be used in conjunction with devices and/or networks operating in accordance with existing Peripheral Component Interconnect Express (PCIe) standards (including PCI Express Base Specification Revision 6.2, Jan. 25, 2024) and/or future versions and/or derivatives thereof, devices and/or networks operating in accordance with existing Compute Express Link (CXL) standards (including Compute Express Link™ (CXL™) Specification, August 2023, Revision 3.1) and/or future versions and/or derivatives thereof, and the like.

The term “communicating” as used herein with respect to a signal, a package, a message, or the like, includes transmitting the signal, package, and/or message, and/or receiving the signal, package, and/or message. For example, a device, which is capable of communicating a signal, package, and/or message, may include a transmitter to transmit (send) the signal, package, and/or message to at least one other device, and/or a receiver to receive the signal, package, and/or message from at least one other device. The verb communicating may be used to refer to the action of transmitting (sending) or the action of receiving. In one example, the phrases “communicating a signal”, “communicating a package”, and/or “communicating a message” may refer to the action of transmitting the signal, package, and/or message by a first device, and may not necessarily include the action of receiving the signal, package, and/or message by a second device. In another example, the phrases “communicating a signal”, “communicating a package”, and/or “communicating a message” may by a first device, and may not necessarily include the action of transmitting the signal, package, and/or message by a second device.

As used herein, the term “circuitry” may refer to, be part of, or include, an integrated circuit, an electronic circuit, analog circuitry, digital circuitry, hard wired circuitry, programmable circuitry, processor circuitry, microcontroller circuitry, hardware logic circuitry, state machine circuitry, an Application Specific Integrated Circuit (ASIC), a processor (shared, dedicated, or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stack, buffers, and/or the like, coupled to the one or more processors, e.g., as necessary to execute the logic.

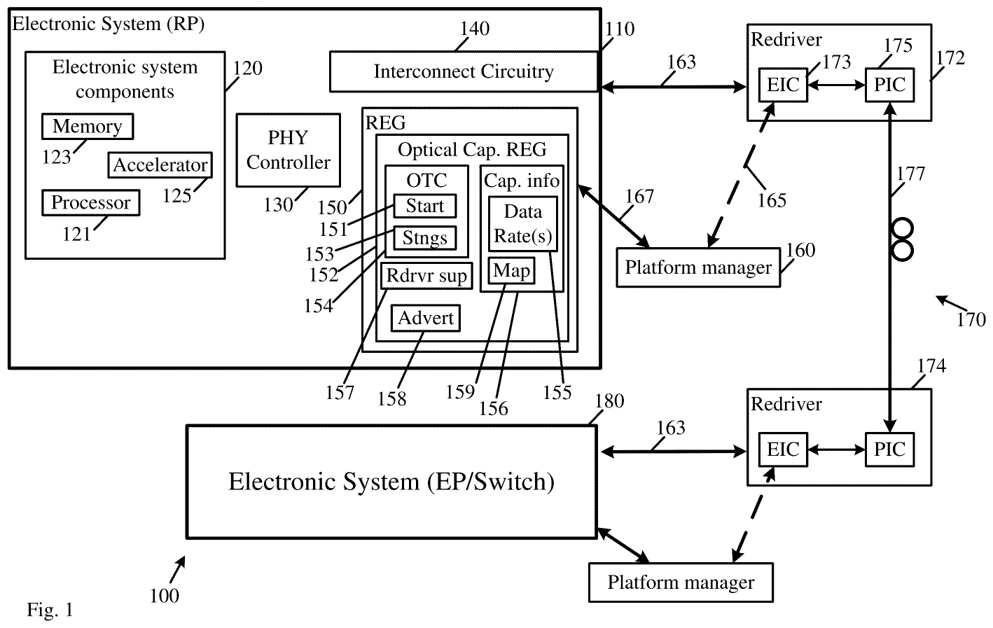

Reference is made to FIG. 1, which schematically illustrates a system 100, in accordance with some demonstrative aspects.

In some demonstrative aspects, one or more elements and/or components of system 100 may be configured to include one or more elements, and/or to perform one or more operations and/or functionalities, according to one or more interconnect technologies, for example, including electrical interconnect technologies and/or optical interconnect technologies, e.g., as described below.

In some demonstrative aspects, one or more elements and/or components of system 100 may be implemented as part of an edge computing system, a cloud computing system, a network communication system, a data center system, a network topology, a communication system, network/switch fabrics, and/or any other additional or alternative system implementation utilizing one or more interconnect technologies.

In some demonstrative aspects, one or more elements and/or components of system 100 may be configured according to, and/or may perform one or more operations and/or functionalities in accordance with, one or more electrical interconnect technologies, for example, a PCIe technology, a CXL technology, and/or other suitable electrical interconnect technology.

In some demonstrative aspects, as shown in FIG. 1, system 100 may include a plurality of electronic systems, for example, electronic system packages, for example, including an electronic system 110 and an electronic system 180, e.g., as described below.

In some demonstrative aspects, an electronic system, e.g., electronic system 110 and/or electronic system 180, may include a System on Chip (SoC) package. For example, electronic system 110 may include a first SoC, and/or electronic system 180 may include a second SoC.

In some demonstrative aspects, an electronic system, e.g., electronic system 110 and/or electronic system 180, may include a System in Package (SiP) package. For example, electronic system 110 may include a first SiP, and/or electronic system 180 may include a second SiP.

In other aspects, an electronic system, e.g., electronic system 110 and/or electronic system 180, may include, or may be implemented as, any other suitable type of electronic system.

In some demonstrative aspects, an electronic system, e.g., electronic system 110 and/or electronic system 180, may include a plurality of electronic system components 120. For example, an electronic system component 120 may include a semiconductor device on a semiconductor die.

In some demonstrative aspects, the electronic system components 120 of an electronic system, e.g., electronic system 110 and/or electronic system 180, may be implemented by a plurality of interconnected dies (also referred to as “chiplets”).

In some demonstrative aspects, the electronic system components 120 of an electronic system, e.g., electronic system 110 and/or electronic system 180, may include, for example, at least one compute (processor) semiconductor device 121, e.g., a Central Processing Unit (CPU) die, a Graphic Processing Unit (GPU) die, and/or any other processor and/or compute die.

In some demonstrative aspects, the electronic system components 120 of an electronic system, e.g., electronic system 110 and/or electronic system 180, may include, for example, at least one accelerator 125, for example, an accelerate die, e.g., a Neural Processing Unit (NPU) die, an Artificial Intelligence (AI) accelerator die, and/or any other accelerator and/or accelerate die.

In some demonstrative aspects, the electronic system components 120 of an electronic system, e.g., electronic system 110 and/or electronic system 180, may include, for example, at least one memory 123, which may be accessible by one or more of the electronic system components 120, for example, via any suitable memory interface. For example, memory 123 may include a Random Access Memory (RAM), a Non-Volatile (NV) memory, and/or other additional or alternative type of memory.

In some demonstrative aspects, the electronic system components 120 of an electronic system, e.g., electronic system 110 and/or electronic system 180, may include, for example, one or more additional or alternative types of semiconductor devices, for example, an Input/Output (I/O) tile die, and/or any other additional or alternative type of dies.

In some demonstrative aspects, the electronic system components 120 of an electronic system, e.g., electronic system 110 and/or electronic system 180, may be interconnected by a plurality of UCIe links according to a UCIe architecture. In other aspects, any other suitable interconnect topology and/or technology may be implemented.

In some demonstrative aspects, as shown in FIG. 1, an electronic system, e.g., electronic system 110 and/or electronic system 180, may include interconnect circuitry 140 (also referred to as “interconnect interface”), which may be configured to communicate over at least one electrical interconnect 163.

In some demonstrative aspects, interconnect circuitry 140 may include suitable communication circuitry, for example, Transmitter (Tx) circuitry to generate and/or transmit (send) one or more messages, data, packets or the like, over the electrical interconnect 163, and/or Receiver (Rx) circuitry to receive and/or process one or more messages, data, packets or the like, over the electrical interconnect 163.

In some demonstrative aspects, interconnect circuitry 140 may include PCIe interconnect circuitry, which may be configured to communicate over electrical interconnect 163 according to a PCIe protocol, e.g., in accordance with a PCIe Specification.

In some demonstrative aspects, interconnect circuitry 140 may include CXL interconnect circuitry, which may be configured to communicate over electrical interconnect 163 according to a CXL protocol, e.g., in accordance with a CXL Specification.

In other aspects, interconnect circuitry 140 may include any other additional or alternative electrical interconnect circuitry, which may be configured to communicate over electrical interconnect 163 according to any other additional or alternative protocol, specification and/or technology.

In some demonstrative aspects, electronic system 110 may be configured as, and/or may perform one or more operations and/or functionalities of, a first port device, e.g., a first PCIe port, a first CXL port, or the like.

In some demonstrative aspects, electronic system 180 may be configured as, and/or may perform one or more operations and/or functionalities of, a second port device, e.g., a second PCIe port, a second CXL port, or the like.

For example, electronic system 110 may be configured as, and/or may perform one or more operations and/or functionalities of a Root Port (RP), e.g., a PCIe RP.

For example, electronic system 110 may be configured as, and/or may perform one or more operations and/or functionalities of an Endpoint (EP) or a switch, e.g., a PCIe EP or switch.

In some demonstrative aspects, as shown in FIG. 1, an electronic system, e.g., electronic system 110 and/or electronic system 180, may include a Physical Layer (PHY) controller 130, which may be configured to control, manage, generate, trigger, and/or cause one or more operations, functionalities and/or communications over the electrical interconnect 163, e.g., as described below.

In some demonstrative aspects, PHY controller 130 may include, or may be implemented, partially or entirely, by circuitry and/or logic, e.g., one or more processors including circuitry and/or logic, memory circuitry and/or logic, Physical Layer (PHY) circuitry and/or logic, and/or any other circuitry and/or logic, configured to perform the functionality of PHY controller 130. Additionally or alternatively, one or more functionalities of PHY controller 130 may be implemented by logic, which may be executed by a machine and/or one or more processors, e.g., as described below.

In one example, PHY controller 130 may include circuitry and/or logic, for example, one or more processors including circuitry and/or logic, to cause, trigger and/or control electronic system 110, to perform one or more operations, communications and/or functionalities, e.g., as described herein. In one example, PHY controller 130 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, as shown in FIG. 1, an electronic system, e.g., electronic system 110 and/or electronic system 180, may include a plurality of registers (REG) 150, which may be configured to store information to configure one or more operations, functionalities, and/or communications over the electrical interconnect 163.

In some demonstrative aspects, registers 150 may be implemented by suitable register circuitry and/or memory circuitry.

In some demonstrative aspects, registers 150 may be implemented as part of PHY controller 130.

In some demonstrative aspects, registers 150 may be implemented as Configuration Space Registers (CSRs), for example, according to a PCIe protocol.

In some demonstrative aspects, registers 150 may be implemented as Control and Status Registers (CSRs), for example, according to a CXL protocol.

In other aspects, registers 150 may be implemented as any other additional or alterative type of registers and/or memory.

In some demonstrative aspects, PHY controller 130 may be configured to access one or more of the registers 150, for example, to write one or more types of information to one or more of the registers 150, and/or to read one or more types of information from one or more of the registers 150, e.g., as described below.

In some demonstrative aspects, as shown in FIG. 1, an electronic system, e.g., electronic system 110 and/or electronic system 180, may be communicatively coupled to a platform management device (platform manager) 160, for example, via a suitable management interface 167.

For example, platform manager 160 may be implemented as a special component and/or integrated circuit which may be configured to manage and/or monitor the functioning of a platform and/or system. For example, platform manager 160 may be implemented as part of a system management and/or system control infrastructure.

For example, platform manager 160 may be configured to support system-level management and/or control functionalities, e.g., to control, monitor, and/or report one or more features of the hardware and/or software of system 100.

For example, platform manager 160 may be configured to access one or more of the registers 150, for example, to write one or more types of information to one or more of the registers 150, and/or to read one or more types of information from one or more of the registers 150, e.g., as described below.

In one example, a PHY controller 130 of a first electronic system, e.g., electronic system 110, may be configured to access one or more of the registers 150 of the first electronic system, for example, to write one or more types of information, e.g., configuration information and/or capability information, corresponding to the first electronic system, e.g., as described below.

In one example, platform manager 160 may be configured to access one or more of the registers 150 of the electronic system, e.g., electronic system 110, for example, to read one or more types of information, e.g., the configuration information and/or capability information, corresponding to the first electronic system, e.g., as described below.

In one example, platform manager 160 may be configured to access one or more of the registers 150 of a second electronic system, e.g., electronic system 180, for example, to read one or more types of information, e.g., configuration information and/or capability information, corresponding to the second electronic system, e.g., as described below.

In one example, platform manager 160 may be configured to access one or more of the registers 150 of the first electronic system, e.g., electronic system 110, and/or the second electronic system, e.g., electronic system 180, for example, to write one or more types of information, e.g., configuration information and/or control information, for example, to configure and/or control one or more operations and/or functionalities to be performed by the first electronic system and/or the second electronic system, e.g., as described below.

In one example, a PHY controller 130 of an electronic system, e.g., electronic system 110 and/or electronic system 180, may be configured to access one or more of the registers 150 of the electronic system, for example, to read one or more types of information, e.g., configuration information and/or control information, for example, to configure and/or control one or more operations and/or functionalities to be performed by the electronic system, e.g., as described below.

In some demonstrative aspects, PHY controller 130 may be configured to perform one or more operations and/or functionalities of a communication mechanism, which may be configured to provide a technical solution to support communication between electronic system 110 and a partner electronic system, e.g., electronic system 180, over a communication path (also referred to as “electrical-optical path”), e.g., an End to End (E2E) communication path, over a combination of an electrical interconnect, e.g., electrical interconnect 163, and an optical interconnect 177, e.g., as described below.

In some demonstrative aspects, the electrical-optical path may be implemented to provide a technical solution to utilize one or more technical aspects and/or advantages of an electrical interconnect technology and/or one or more technical aspects and/or advantages of an optical interconnect technology, e.g., as described below.

For example, electrical interconnects may be implemented to provide a technical solution to handle the transmission of electrical signals, e.g., using copper wires and/or traces on a printed circuit board (PCB). For example, electrical interconnects may be implemented to provide a technical solution to support short-range, high-speed signaling, for example, between components of a device, or between nearby devices.

For example, optical interconnects may use optical fibers and/or waveguides to communicate light signals. For example, optical interconnects may be implemented to provide a technical solution to support high-speed, long-distance communication, e.g., with relatively low signal degradation and/or immunity to electromagnetic interference. For example, optical interconnects may be implemented to provide a technical solution to support relatively long-range data communication, for example, to connect between devices located at a relatively large distance from each other.

For example, optical interconnect technology may be utilized to provide a technical solution to extend the channel reach of electrical interconnects, e.g., PCIe interconnects, CXL interconnects, or the like, for example, to support rack and/or pod level disaggregation.

For example, when combining an electrical interconnect with an optical interconnect, there may be a challenge to provide a technical solution to convert an E2E protocol dependency of an electrical interconnect technology, e.g., a PCIe/CXL technology, on an electrical specification including training, power management, or the like.

One solution to address this challenge may be to use a switching type approach with a full PCIe stack, and separate optical channels for sideband communication, e.g., to ensure interoperability. However, this solution may result in relatively high latency, increased power consumption, and/or increased cost, e.g., in terms of time, resource consumption, and/or physical hardware space.

In some demonstrative aspects, PHY controller 130 may be configured to perform one or more operations and/or functionalities of a redriver-based communication mechanism, which may be configured to support implementation of the optical interconnect 177 in the form of, or as part of, a redriver-based optical interconnect 170, e.g., as described below.

In some demonstrative aspects, the redriver-based communication mechanism may be configured to provide a technical solution to support E2E communication over an electrical-optical path, for example, by using an optical interconnect, e.g., the redriver-based optical interconnect 170, including an electrical-interconnect agnostic redriver, e.g., a PCIe-agnostic redriver, e.g., as described below.

In some demonstrative aspects, the redriver-based communication mechanism may be configured to provide a technical solution to support implementation of the redriver-based optical interconnect 170, for example, with a reduced level of changes, e.g., minimal changes, to ports of the electrical interconnect, e.g., PCIe ports and/or CXL ports, e.g., as described below.

In some demonstrative aspects, the redriver-based communication mechanism may be configured to provide a technical solution to support increased data speeds for communication over the electrical interconnect PHY, e.g., the PCIe PHY, e.g., as described below.

In some demonstrative aspects, the redriver-based communication mechanism may be configured to provide a technical solution to support implementation by carefully constructed platforms, for example, where an end-to-end channel loss, e.g., including both ends of the optical interconnect 177, may be within one channel loss, and/or where the redriver-based optical interconnect may operate substantially linearly across an operating voltage range, e.g., across process, voltage, and/or temperature variations, e.g., as described below.

In some demonstrative aspects, the redriver-based communication mechanism may be configured to provide a technical solution to support E2E communication between electronic systems, e.g., electronic system 110 and electronic system 180, via the redriver-based optical interconnect 170, for example, with reduced power, cost and/or latency, e.g., as described below.

In some demonstrative aspects, the redriver-based communication mechanism may be configured to provide a technical solution to utilize an optical link, e.g., a PCIe-agnostic redriver-based optical link, to interface with two ports, for example, PCIe/CXL Ports, e.g., electronic system 110 and electronic system 180, as described below.

In some demonstrative aspects, the redriver-based communication mechanism may be configured to provide a technical solution to support the two ports, e.g., electronic system 110 and electronic system 180, to communicate with each other using optical media, for example, in a way which may effectively provide an end-to-end connection between the two ports, for example, in a manner similar to an electrical connection between the ports, e.g., as described below.

In some demonstrative aspects, redriver-based optical interconnect 170 may include a redriver 172 and a redriver 174, which may be configured to interface between the electrical interconnect 163 and optical interconnect 177, e.g., as described below.

In some demonstrative aspects, redriver 172 and/or redriver 174 may include a Linear-drive Pluggable Optics (LPO) redriver, and/or any other additional or alternative suitable type of optical redriver.

In some demonstrative aspects, as shown in FIG. 1, a redriver, e.g., redriver 172 and/or redriver 174, may include an Electronic Integrated Circuit (also referred to as “Electronic Interface Circuitry”) (EIC) 173, and a Photonic Integrated Circuit (also referred to as “Photonic Interface Circuitry”) (PIC) 175, e.g., as described below.

In some demonstrative aspects, PIC 175 may be configured to communicate optical signals over the optical interconnect 177, for example, according to a suitable optical communication technology. For example, PIC 175 may include one or more photonic devices, e.g., lasers, modulators, detectors, waveguides, and/or other optical elements with electronic components for signal processing and/or control.

In some demonstrative aspects, EIC 173 may be configured to interface between the electrical interconnect 163 and the PIC 175. For example, EIC 173 may be configured to capture bits from electrical interconnect 163 and to convert the captured bits into signals to be communicate by the PIC 175 over the optical interconnect 177. For example, EIC 173 may be configured to capture signals from PIC 175 and to convert the captured signals into bits to be communicate over the electrical interconnect 163. For example, EIC 173 may be configured to orchestrate link training between the two ports.

In some demonstrative aspects, EIC 173 may be configured to monitor its optical link health status, e.g., in terms of readiness, errors, or the like. For example, EIC 173 may be configured to communicate information corresponding to its optical link health status, e.g., through a sideband link 165, for example, to a management entity in its local port, e.g., to the platform manager 160.

In some demonstrative aspects, the redriver-based optical interconnect 170 may be required to meet one or more performance criteria, e.g., as described below.

For example, it may be defined that a link between the electronic system 110 and electronic system 180 via the redriver-based optical interconnect 170 is required to conform to a Bit Error Rate (BER) assumption, e.g., a First Bit Error Rate (FBER) assumption, and/or a Flit error rate assumption, e.g., in accordance with the PCIe Specification, for example, also for the optical path.

In one example, the link, e.g., the E2E link between the electronic system 110 and electronic system 180 via the redriver-based optical interconnect 170, may operate in a non-Flit mode, for example, at a rate of 32 Giga-Transfers per Second (GT/s).

According to this example, the E2E link, e.g., including the optical path, may be required to support a BER better than 10⁻¹², and, in a flit mode, an FBER better than 10⁻⁶ and a Flit retry probability better than 3×10⁻⁵.

In other aspects, any other additional or alternative constraints and/or requirements may be defined for the link, e.g., the E2E link between the electronic system 110 and electronic system 180 via the redriver-based optical interconnect 170, and/or the redriver-based optical interconnect 170.

In some demonstrative aspects, the platform manager 160 may be able to update in registers 150 system information corresponding to one or more system topologies, one or more system configurations, and/or one or more system capabilities, for example, whether or not Separate Reference Independent Spread (SRIS) is implemented, frequencies supported by the optical interconnect 177, or the like, e.g., as described below.

In some demonstrative aspects, PHY controller 130 may be configured to access the system information in the registers 150, and to configure a link between electronic system 110 and electronic system 180, for example, via the electric interconnect 163 and the optical interconnect 177, e.g., as described below.

In some demonstrative aspects, PHY controller 130 may be configured to access a plurality of optical-capability (Optical Cap.) registers 152 to identify Optical-Training Control (OTC) information 154, e.g., as described below.

In some demonstrative aspects, PHY controller 130 may be configured to access the plurality of optical-capability registers 152 to identify optical-capability (Cap.) information 156, e.g., as described below.

In some demonstrative aspects, at least art of, e.g., some or all of, the OTC information 154 and/or the optical-capability information 156 may be written to the optical-capability registers 152, for example, via platform manager 160 and/or any other suitable component of system 100.

In some demonstrative aspects, as shown in FIG. 1, the plurality of optical-capability registers 152 may be implemented as part of the registers 150, e.g., as described below.

In some demonstrative aspects, the plurality of optical-capability registers 152 may be implemented as part of an optical-capability register structure, for example, in the form of an optical-capability CSR, e.g., as described below.

In some demonstrative aspects, PHY controller 130 may be configured to access a first 32-bit register of the plurality of optical-capability registers 152, for example, to identify the optical-capability information 156, e.g., as described below.

In some demonstrative aspects, PHY controller 130 may be configured to access a second 32-bit register of the plurality of optical-capability registers 152, for example, to identify the optical-training control information 154, e.g., as described below.

In other aspects, the plurality of optical-capability registers 152 may be implemented according to any other suitable register structure and/or architecture.

In some demonstrative aspects, PHY controller 130 may be configured to access the optical-capability registers 152 to identify a start-training bit 151, for example, in the optical-training control information 154, e.g., as described below.

In some demonstrative aspects, PHY controller 130 may be configured to determine whether the start-training bit 151 is set to a predefined value, for example, to indicate that an optical-based link training procedure is to be performed, e.g., as described below.

In some demonstrative aspects, PHY controller 130 may be configured to initiate an optical-based link training procedure, for example, based on a determination that the start-training bit 151 is set to the predefined value, e.g., as described below.

In some demonstrative aspects, the optical-based link training procedure may be performed via the electrical interconnect 163, for example, to train a link between the electronic system 110 and the partner electronic system 180, for example, over the redriver-based optical interconnect 170, e.g., as described below.

In some demonstrative aspects, PHY controller 130 may be configured to perform one or more operations of the optical-based link training procedure, for example, based on the optical-capability information 156, e.g., as described below.

In some demonstrative aspects, the predefined value of the start-training bit 151 may be 1. In other aspects, any other value may be implemented.

In some demonstrative aspects, the predefined value of the start-training bit 151 may be set, for example, by the platform manager 160, for example, to indicate to the PHY controller 130 that the optical-based link training procedure is to be performed.

In some demonstrative aspects, the predefined value of the start-training bit 151 may be set, for example, by the platform manager 160, for example, based on a determination that the optical-based link training procedure is supported by the electronic system 110 and the electronic system 180, e.g., as described below.

In some demonstrative aspects, the platform manager 160 may determine whether the optical-based link training procedure is supported by an electronic system, e.g., electronic system 110, for example, based on a support indication set by the electronic system, e.g., as described below.

In some demonstrative aspects, PHY controller 130 may be configured to set a redriver-support bit 157 in the optical-capability registers 152 to a predefined value, for example, to indicate that the PHY controller 130 supports communication over the redriver-based optical interconnect 170, e.g., as described below.

In some demonstrative aspects, PHY controller 130 may be configured to initiate the optical-based link training procedure, for example, over the electrical interconnect 163 including a PCIe interconnect, for example, to train a PCIe link over the redriver-based optical interconnect 170, e.g., as described below.

In some demonstrative aspects, PHY controller 130 may be configured to initiate the optical-based link training procedure, for example, over the electrical interconnect 163 including a CXL interconnect, for example, to train a CXL link over the redriver-based optical interconnect 170.

In other aspects, PHY controller 130 may be configured to initiate the optical-based link training procedure, for example, over the electrical interconnect 163 including any other type of electrical interconnect, for example, to train any other suitable type of link over the redriver-based optical interconnect 170.

In some demonstrative aspects, PHY controller 130 may be configured to identify in the optical-capability information 156 supported data rate information 155 to indicate one or more supported data rates for communication over the redriver-based optical interconnect 177, e.g., as described below.

In some demonstrative aspects, PHY controller 130 may be configured to perform one or more operations of the optical-based link training procedure, for example, based on the supported data rate information, e.g., as described below.

In some demonstrative aspects, PHY controller 130 may be configured to identify in the supported data rate information 155 a plurality of data-rate bits corresponding to a respective plurality of data rates, e.g., as described below.

In some demonstrative aspects, PHY controller 130 may be configured to determine, e.g., based on a setting of a data-rate bit to “1”, that a data rate corresponding to the data-rate bit is supported, e.g., as described below.

In some demonstrative aspects, the plurality of data-rate bits may include 7 bits, for example, corresponding to 7 different data rates, e.g., as described below.

In other aspects, the plurality of data-rate bits may include any other number of data-rate bits corresponding to any other number of data rates.

In some demonstrative aspects, PHY controller 130 may be configured to determine whether or not a lowest data rate of the electrical interconnect 163 is included in the one or more supported data rates for communication over the redriver-based optical interconnect 170, for example, based on the supported data rate information 155, e.g., as described below.

In some demonstrative aspects, PHY controller 130 may be configured to identify one or more optical training control settings, for example, based on the optical-training control information 154, e.g., as described below.

In some demonstrative aspects, PHY controller 130 may be configured to identify the one or more optical training control settings, for example, based on OTC setting information 153 in the optical-training control information 154, e.g., as described below.

In some demonstrative aspects, PHY controller 130 may be configured to control the optical-based link training procedure, for example, based on the one or more optical training control settings, e.g., as described below.

In some demonstrative aspects, PHY controller 130 may be configured to identify in optical training control information 154, e.g., in OTC setting information 153, training time information to indicate a training time period corresponding to the electronic system 110, e.g., as described below.

For example, OTC setting information 153 may include the training time information to indicate a training time period corresponding to the electronic system 110 in microseconds, e.g., as described below.

In some demonstrative aspects, PHY controller 130 may be configured to wait for the training time period corresponding to the electronic system 110, for example, after sending a training pattern and before counting a timeout counter for receipt of a training pattern from the partner electronic system 180, e.g., as described below.

In some demonstrative aspects, PHY controller 130 may be configured to identify in optical training control information 154, e.g., in OTC setting information 153, pattern type information to indicate a training pattern type, e.g., as described below.

For example, OTC setting information 153 may include the pattern type information to indicate a training pattern type, for example, to indicate one or more training pattern types to be used by the electronic system 110 for link training according to the optical-based link training procedure, e.g., as described below.

In some demonstrative aspects, PHY controller 130 may be configured to transmit a training pattern according to the training pattern type during the optical-based link training procedure, e.g., as described below.

In some demonstrative aspects, PHY controller 130 may be configured to identify in optical training control information 154, e.g., in OTC setting information 153, a train-every-data-rate bit, e.g., as described below.

For example, OTC setting information 153 may include the train-every-data-rate bit to indicate whether or not every data rate is to be trained during the optical-based link training procedure, e.g., as described below.

In some demonstrative aspects, PHY controller 130 may be configured to transition from a detect state of the optical-based link training procedure to a configuration optical training (Configuration.OpticalTrain) state of the optical-based link training procedure, for example, based on a determination that a lowest data rate of the electrical interconnect 163 is not included in the one or more supported data rates for communication over the redriver-based optical interconnect 170, e.g., as described below.

In some demonstrative aspects, the Configuration.OpticalTrain state may include an exchange of one or more training patterns between the electronic system 110 and the partner electronic system 180, for example, according to one or more optical training control settings based on, e.g., defined by, associated with, corresponding to, and/or represented by, the optical-training control information 154, for example, by OTC setting information 153, e.g., as described below.

In some demonstrative aspects, PHY controller 130 may be configured to transition from the detect state of the optical-based link training procedure to a polling state, for example, based on a determination that the lowest data rate of the electrical interconnect 163 is included in the one or more supported data rates for communication over the redriver-based optical interconnect 170, e.g., as described below.

In some demonstrative aspects, PHY controller 130 may be configured to set a target data rate for the link between the electronic system 110 and the partner electronic system 180, e.g., for an L0 state, for example, based on a first maximal data rate and a second maximal data rate, e.g., as described below.

In some demonstrative aspects, the first maximal data rate may include a maximal data rate of the one or more supported data rates, for example, according to the supported data rate information 155, e.g., as described below.

In some demonstrative aspects, the second maximal data rate may include a maximal data rate supported by the partner electronic system 180, e.g., as described below.

In some demonstrative aspects, PHY controller 130 may be configured to set the target data rate for the link between the electronic system 110 and the partner electronic system 180, for example, based on a lowest one of the first maximal data rate and the second maximal data rate, e.g., as described below.

In other aspect, the target data rate may be set according to any other additional or alternative criteria, setting, and/or definition.

In some demonstrative aspects, PHY controller 130 may be configured to initiate a recovery optical training (Recovery.Optical.Train) state to train the target data rate, e.g., as described below.

In some demonstrative aspects, PHY controller 130 may be configured to initiate the Recovery.Optical.Train state to train the target data rate, for example, based on a determination that the target data rate is greater than a currently trained data rate, e.g., as described below.

In some demonstrative aspects, PHY controller 130 may be configured to identify that a next data rate, e.g., which is higher than the current data rate, is to be trained, e.g., as described below.

In some demonstrative aspects, PHY controller 130 may be configured to identify that the next data rate is to be trained, for example, based on a determination that the optical-training control information 154 indicates a requirement to train every data rate, e.g., as described below.

In some demonstrative aspects, the PHY controller 130 may be configured to initiate the Recovery.Optical.Train state, for example, to train the next data rate, e.g., as described below.

In some demonstrative aspects, the PHY controller 130 may be configured to exchange one or more training patterns between the electronic system 110 and the partner electronic system 180, for example, at the Configuration.OpticalTrain state of the optical-based link training procedure, e.g., as described below.

In some demonstrative aspects, the PHY controller 130 may be configured to exchange the one or more training patterns between the electronic system 110 and the partner electronic system 180, for example, according to one or more optical training control settings based on, e.g., defined by, associated with, corresponding to, and/or represented by, the optical-training control information 154, for example, by OTC setting information 153, e.g., as descried below.

In some demonstrative aspects, the PHY controller 130 may be configured to determine a training time period corresponding to the electronic system 110 for example, based on the optical-training control information 154, e.g., as descried below.

In some demonstrative aspects, the PHY controller 130 may be configured to wait the training time period, for example, after sending a training pattern to the partner electronic system 180 via the electrical interconnect 163, e.g., as described below.

In some demonstrative aspects, the PHY controller 130 may be configured to send a training pattern to the partner electronic system 180 via the electrical interconnect 163, for example, at the Configuration.OpticalTrain state, e.g., as described below.

In some demonstrative aspects, the PHY controller 130 may be configured to wait for the training time period corresponding to the electronic system 110, for example, after sending the training pattern, e.g., as described below.

In some demonstrative aspects, the one or more optical training control settings based on, e.g., defined by, associated with, corresponding to, and/or represented by, the optical-training control information 154, for example, by OTC setting information 153, may include the training time period corresponding to the electronic system 110, e.g., as described below.

In some demonstrative aspects, the PHY controller 130 may be configured to start a timeout counter, for example, after the training time period corresponding to the electronic system 110, e.g., as described below.

In some demonstrative aspects, the PHY controller 130 may be configured to wait for a predefined time period, for example, based on expiration of the timeout counter, e.g., as described below.

In some demonstrative aspects, the PHY controller 130 may be configured to send the training pattern to the partner electronic system 180, for example after the predefined time period, e.g., as described below.

In some demonstrative aspects, the PHY controller 130 may be configured to reset the timeout counter, for example, based on receipt of a training pattern from the partner electronic system 180 including, for example, an optical-training bit set to a predefined value, e.g., as described below.

In some demonstrative aspects, the predefined value of the optical-training bit may be configured to indicate that the partner electronic system 180 has not yet reached a training time corresponding to the partner electronic system 180, e.g., as described below.

In some demonstrative aspects, the timeout counter may be configured to count a timeout period of a first duration, e.g., as described below.

In some demonstrative aspects, the predefined time period, e.g., after the expiration of the timeout counter, may have a second duration, for example, longer than the first duration of the timeout period, e.g., as described below.

In some demonstrative aspects, the predefined time period, e.g., after the expiration of the timeout counter, may be implemented to provide a technical solution to provide additional time, which may be required for training over the redriver-based optical interconnect 170, e.g., as described below.

In some demonstrative aspects, the predefined time period, e.g., after the expiration of the timeout counter, may be configured to have a duration, which may be longer than the duration of the timeout period, for example, to provide a technical solution to support additional time, which may be required by the partner electronic system 180 for training over the redriver-based optical interconnect 170, e.g., as described below.

In some demonstrative aspects, the timeout counter may be configured to count a timeout period of 24 milliseconds (ms), e.g., as described below.

In some demonstrative aspects, the predefined time period, e.g., after the expiration of the timeout counter, may have a duration of 48 milliseconds, e.g., as described below.

In other aspects, any other suitable setting of the timeout period and/or the predefined time period, e.g., after the expiration of the timeout counter, may be implemented.

In some demonstrative aspects, the PHY controller 130 may be configured to switch from the Configuration.OpticalTrain state to a configuration link-width start (Configuration.LinkWidth.Start) state, e.g., as described below.

In some demonstrative aspects, the PHY controller 130 may be configured to switch from the Configuration.OpticalTrain state to Configuration.LinkWidth.Start state, for example, based on a determination that a predefined bit transition criterion is met with respect to training pattern bits received from the partner electronic system 180, e.g., as described below.

In some demonstrative aspects, the PHY controller 130 may be configured to switch back from the Configuration.LinkWidth.Start state to the Configuration.OpticalTrain state, for example, based on expiration of a timer of a predefined timeout period, e.g., as described below.

In some demonstrative aspects, the PHY controller 130 may be configured to reset the timer of the predefined timeout period, for example, based on a predefined criterion relating to the Configuration.LinkWidth.Start state, e.g., as described below.

In some demonstrative aspects, the PHY controller 130 may be configured to reset the timer of the predefined timeout period, for example, based on receipt of two consecutive training patterns from the partner electronic system, which include an optical-training bit set to a predefined value, e.g., as described below.

In some demonstrative aspects, the predefined value of the optical-training bit may indicate that the partner electronic system 180 has not yet reached a training time corresponding to the partner electronic system 180, e.g., as described below.

In some demonstrative aspects, the PHY controller 130 may be configured to switch from a current data rate to a next higher supported data rate, for example, when switching back from the Configuration.LinkWidth.Start state to the Configuration.OpticalTrain state, e.g., as described below.

In some demonstrative aspects, the PHY controller 130 may be configured to switch from the current data rate to the next higher supported data rate, for example, based on a determination that the timer of the predefined timeout period has expired for a predefined number of times, e.g., as described below.

In some demonstrative aspects, the predefined number of times may be 5.

In other aspects, the PHY controller 130 may be configured to switch from the current data rate to the next higher supported data rate, for example, based on a determination that the timer of the predefined timeout period has expired for any other number of times, and/or based on any other additional or alternative criteria.

In some demonstrative aspects, optical-capability information 156 may be configured to include mapping-capability information 159 to indicate at least one supported type of bit-mapping between the electric interconnect 163 and the redriver-based optical interconnect 170, e.g., as described below.

In some demonstrative aspects, the mapping-capability information 159 may include a plurality of bits corresponding to a plurality of mapping schemes, e.g., a described below.

In some demonstrative aspects, the mapping-capability information 159 may include a strict-mapping bit, which may be configured to indicate whether a strict mapping between electrical lanes and optical lanes (channels) is supported, e.g., as described below.

In some demonstrative aspects, the mapping-capability information 159 may include a flexible-mapping (flex map) bit, which may be configured to indicate whether a flexible mapping between electrical lanes and optical lanes (channels) is supported, e.g., as described below.

In other aspects, the mapping-capability information 159 may include any other additional or alternative bits to indicate whether any other additional or alternative mapping schemes are supported.

In some demonstrative aspects, the PHY controller 130 may be configured to set the mapping-capability information 159 to indicate which one or more mapping schemes are supported at a receiver of the electronic system 110.

In one example, the PHY controller 130 may be configured to set the strict-mapping bit to a predefined value, e.g., 1, to indicate that the receiver of the electronic system 110 supports the strict mapping between electrical lanes and optical lanes, e.g., as described below.

In another example, the PHY controller 130 may be configured to set the flexible-mapping bit to a predefined value, e.g., 1, to indicate that the receiver of the electronic system 110 supports flexible mapping between electrical lanes and optical lanes, e.g., as described below.

In some demonstrative aspects, the mapping-capability information 159 may be utilized to provide a technical solution to support coordination and/or setting up of the E2E communication path between the electronic system 110 and the electronic system 180, for example, via the redriver-based optical interconnect 170.

For example, the platform manager 160 may be configured to read the mapping-capability information 159 from the electronic system 110, for example, to determine which one or more types of mapping schemes are supported by the electronic system 110.

For example, the platform manager 160 may be configured to read the mapping-capability information 159 from the electronic system 180, for example, to determine which one or more types of mapping schemes are supported by the electronic system 180.

For example, a setting and/or configuration of the redriver-based optical interconnect 170 may be determined, for example, based on the one or more types of mapping schemes supported by the electronic system 110, and/or the one or more types of mapping schemes supported by the electronic system 180.

In some demonstrative aspects, PHY controller 130 may be configured to write to the plurality of optical-capability registers 152 advertised information 158, e.g., as described below.

In some demonstrative aspects, PHY controller 130 may be configured to set link partner data rate information in the optical-capability registers 152, for example, as part of advertised information 158, e.g., as described below.

In some demonstrative aspects, the link partner data rate information may be configured to indicate one or more data rates advertised by the partner electronic system 180.

For example, PHY controller 130 may be configured to identify the one or more data rates advertised by the partner electronic system 180, for example, based on information received from the partner electronic system 180.

In some demonstrative aspects, PHY controller 130 may be configured to set a flexible-mapping bit in the optical-capability registers 152, for example, as part of advertised information 158, e.g., as described below.

In some demonstrative aspects, PHY controller 130 may be configured to set the flexible-mapping bit, for example, to indicate use of a flexible mapping to map optical lanes of the redriver-based optical interconnect 170 to receiver electrical lanes at the electronic system 110, e.g., as described below.

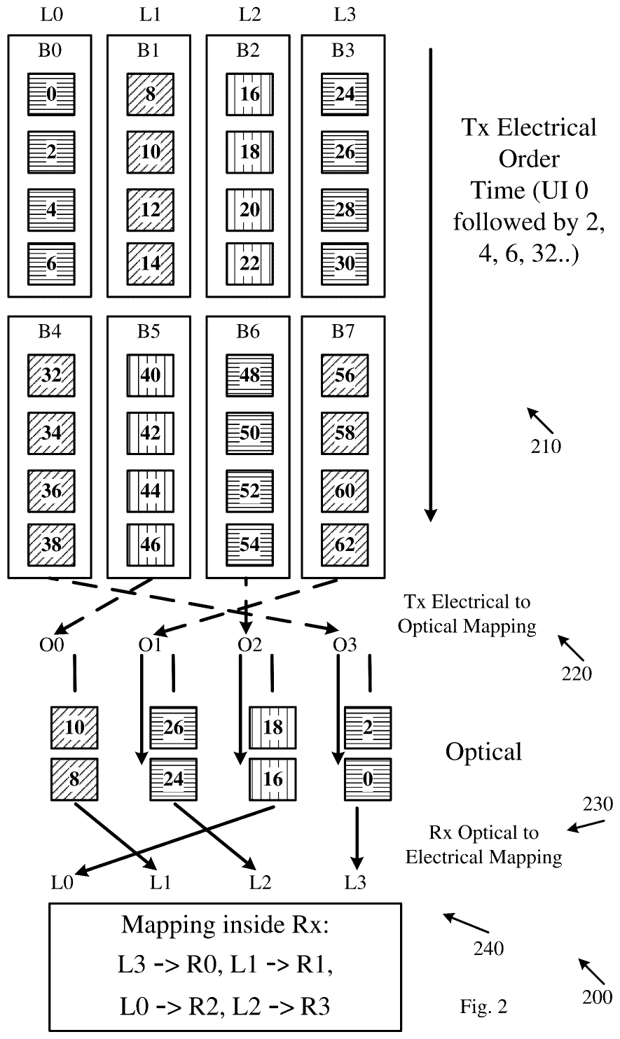

Reference is made to FIG. 2, which schematically illustrates a flexible mapping scheme 200, which may be implemented for communication via a link over a redriver-based optical interconnect, in accordance with some demonstrative aspects.

For example, a receiver of an electronic system may be configured to process received bit streams according to the flexible mapping scheme 200, for example, to process the received bit streams according to an order of transmission of the received bit streams, e.g., as described below.

For example, PHY controller 130 (FIG. 1) may be configured to process received bit streams, which are received over electrical interconnect 163 (FIG. 1), for example, according to the flexible mapping scheme 200, for example, to process the received bit streams according to an order of transmission of the received bit streams from the electronic system 180 (FIG. 1), e.g., as described below.

In some demonstrative aspects, as shown in FIG. 2, bit streams, e.g., data streams and/or ordered sets, may be mapped by an optical interconnect, e.g., optical interconnect 170 (FIG. 1), between an electrical channel and an optical channel, and/or between the optical channel to the electrical channel, for example, on a per-UI (unit interval) basis.

In some demonstrative aspects, as shown in FIG. 2, a plurality of bit streams may be transmitted at transmitter (Tx) side 210 over a plurality of electrical lanes of an electrical interconnect.

For example, as shown in FIG. 2, the plurality of electrical lanes may include four electrical lanes, denoted L0, L1, L2, and L3.

In some demonstrative aspects, as shown in FIG. 2, the optical interconnect may apply a first mapping (Tx electrical to optical mapping) 220 to map the plurality of bit streams on the transmitter side 210 from the plurality of electrical lanes of the electrical interconnect to a plurality of optical lanes of the optical interconnect.

In some demonstrative aspects, as shown in FIG. 2, the plurality of optical lanes (channels) may include four optical lanes (channels), denoted O0, O1, O2, and O3.

In some demonstrative aspects, as shown in FIG. 2, the optical interconnect may apply a second mapping (Rx optical to electrical mapping) 230 to map the plurality of optical lanes (channels) of the optical interconnect back to the plurality of electrical lanes of the electrical interconnect at a receiver (Rx) side 240.

In one example, redriver 174 (FIG. 1) may apply the first mapping 220 to map bit streams, e.g., transmitted from the electronic system 180 (FIG. 1) over the plurality of electrical lanes of the electrical interconnect 163 (FIG. 1), to optical lanes of the optical interconnect 170 (FIG. 1). According to this example, redriver 172 (FIG. 1) may apply the second mapping 230 to map the plurality of optical lanes of the optical interconnect 170 (FIG. 1) back to the plurality of electrical lanes of the electrical interconnect 163 (FIG. 1) at the receiver side of the electronic system 110 (FIG. 1).

In another example, redriver 172 (FIG. 1) may apply the first mapping 220 to map bit streams, e.g., transmitted from the electronic system 110 (FIG. 1) over the plurality of electrical lanes of the electrical interconnect 163 (FIG. 1), to optical lanes of the optical interconnect 170 (FIG. 1). According to this example, redriver 174 (FIG. 1) may apply the second mapping 230 to map the plurality of optical lanes of the optical interconnect 170 (FIG. 1) back to the plurality of electrical lanes of the electrical interconnect 163 (FIG. 1) at the receiver side of the electronic system 180 (FIG. 1).

In some demonstrative aspects, as shown in FIG. 2, the first mapping 220 may include a mapping of one electrical lane, e.g., one of the electrical lanes L0-L3, to a respective optical lane, e.g., one of optical lanes O0-O3.

In some demonstrative aspects, as shown in FIG. 2, the second mapping 230 may include a mapping of one optical lane, e.g., one of the optical lanes O0-O3, to a respective electrical lane, e.g., one of electrical lanes L0-L3.

In some demonstrative aspects, a strict mapping scheme may be configured, for example, such that the first mapping 220 and the second mapping 230 include mapping between an i-th electrical lane and an i-th optical lane, for example, such that each i-th electrical lane is mapped to a respective i-th optical channel, e.g., on either the Tx and Rx ports. For example, according to the strict mapping scheme, a receiver side on the electrical interconnect may handle a lane reversal, e.g., a normal lane reversal, if needed, on one port to make the connectivity.

In some demonstrative aspects, as shown in FIG. 2, mapping scheme 200 may be configured as a flexible (flex) mapping scheme, for example, where any suitable mapping may be permitted, for example, between the electrical lanes and the optical channels.

For example, as shown in FIG. 2, the first mapping 220 may include a mapping of the electrical lane L0 to the optical channel O3, a mapping of the electrical lane L1 to the optical channel O0, a mapping of the electrical lane L2 to the optical channel O2, and a mapping of the electrical lane L3 to the optical channel O1.

For example, as shown in FIG. 2, the second mapping 230 may include a mapping of the optical channel O0 to the electrical lane L1, a mapping of the optical channel O1 to the electrical lane L2, a mapping of the optical channel O2 to the electrical lane L0, and a mapping of the optical channel O3 to the electrical lane L3.

In other aspects, any other suitable flex mapping scheme may be implemented.

In some demonstrative aspects, when implementing the flexible mapping scheme, the receiver side 240 may be configured to support a w:1 map, wherein w denotes the link width, e.g., the number of lanes per link. For example, as shown in FIG. 2, the link width may be w=4 for the mapping scheme 200. For example, the receiver side 240 may be configured to support the w:1 map, or example, for each electrical lane, e.g., independent of the Tx side 210.

In some demonstrative aspects, the Rx side 240 may configure an Rx lane, e.g., each Rx lane, to have a w:1 map, which may be configured, for example, during link training.

For example, as shown in FIG. 2, the Rx side 240 may implement a mapping of the Rx electrical lane L3 to an Rx queue, denoted R0, corresponding to the Tx lane L0.

For example, as shown in FIG. 2, the Rx side 240 may implement a mapping of the Rx electrical lane L1 to an Rx queue, denoted R1, corresponding to the Tx lane L1.

For example, as shown in FIG. 2, the Rx side 240 may implement a mapping of the Rx electrical lane L0 to an Rx queue, denoted R2, corresponding to the Tx lane L2.

For example, as shown in FIG. 2, the Rx side 240 may implement a mapping of the Rx electrical lane L2 to an Rx queue, denoted R3, corresponding to the Tx lane L3.

In some demonstrative aspects, a system designer, e.g., of system 100 (FIG. 1), may ensure that both sides of a link, e.g., electronic system 110 and electronic system 180, are capable of supporting the flex map, for example, before deploying optical solutions, e.g., redriver-based optical interconnect 170 (FIG. 1), which may require the implementation of the flex map.

In some demonstrative aspects, the platform manager 160 (FIG. 1) may access the mapping information 159 (FIG. 1) in the optical-capability registers 152 (FIG. 1) of electronic system 110 (FIG. 1), for example, to determine whether or not the electronic system 110 (FIG. 1) supports the flex map, e.g., as described above.

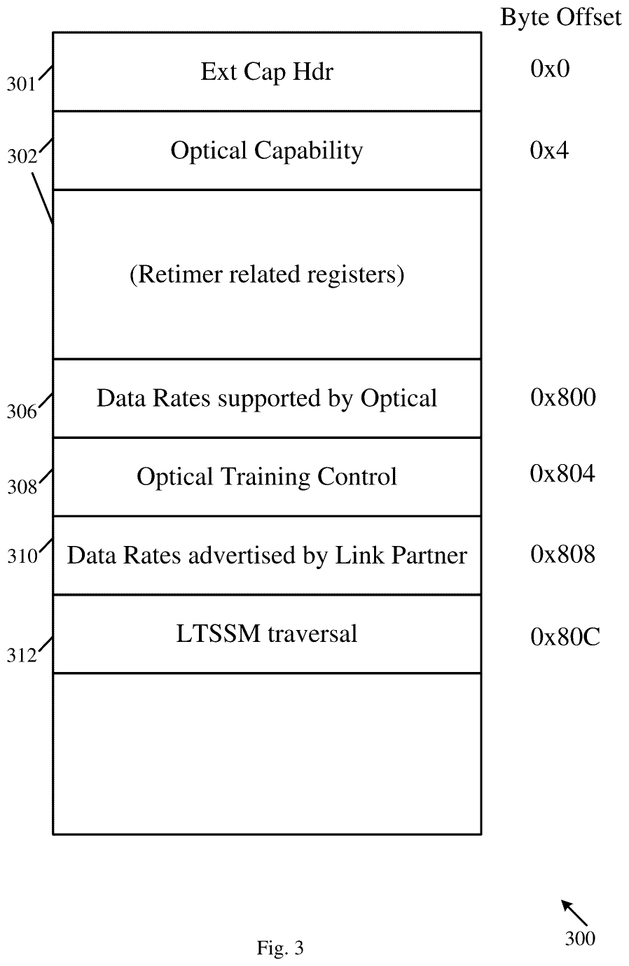

Reference is made to FIG. 3, which schematically illustrates an optical-capability register structure 300, in accordance with some demonstrative aspects.

For example, one or more, e.g., some or all, of the optical-capability registers 152 (FIG. 1), may be implemented according to the optical-capability register structure 300.

For example, optical-capability register structure 300 may be implemented by CSRs of an electronic system, e.g., electronic system 110 (FIG. 1).

In some demonstrative aspects, optical-capability register structure 300 may be configured to indicate one or more optical-related functionalities supported by an electronic system, e.g., electronic system 110 (FIG. 1), including the optical-capability register structure 300, e.g., as described below.

In some demonstrative aspects, optical-capability register structure 300 may be configured to indicate one or more optical-related capabilities of the electronic system, e.g., electronic system 110 (FIG. 1), including the optical-capability register structure 300, e.g., as described below.

In some demonstrative aspects, optical-capability register structure 300 may be configured to maintain control information to control one or more optical-related functionalities of the electronic system, e.g., electronic system 110 (FIG. 1), including the optical-capability register structure 300, e.g., as described below.

In some demonstrative aspects, optical-capability register structure 300 may be configured to indicate status information corresponding to one or more optical-related functionalities of the electronic system, e.g., electronic system 110 (FIG. 1), including the optical-capability register structure 300, e.g., as described below.

In some demonstrative aspects, optical-capability register structure 300 may be configured to support redriver-based functionalities and/or retimer-based functionalities, e.g., as described below.

In some demonstrative aspects, as shown in FIG. 3, optical-capability register structure 300 may include an extended capability header 301, which may be configured to indicate that the register structure is the optical-capability register structure 300, and/or a format of the optical-capability register structure 300.

In some demonstrative aspects, optical-capability register structure 300 may include a particular arrangement of registers and/or bits, e.g., as shown in FIG. 3. In other aspects, information in the optical-capability register structure 300 may be configured according to any other suitable register arrangement and/or bit arrangement.

In some demonstrative aspects, as shown in FIG. 3, optical-capability register structure 300 may include at least one register 302, which may be configured to include capability information to identify one or more optical-related capabilities of the electronic system including the optical-capability register structure 300, e.g., as described below.

In some demonstrative aspects, the at least one register 302 may include a redriver-support bit, which may be configured to indicate support of communication over a redriver-based optical interconnect. For example, the register 302 may include redriver-support bit 157 (FIG. 1), e.g., as described above.

In some demonstrative aspects, the at least one register 302 may include one or more bits to indicate retimer information corresponding to a retimer-based optical interconnect.

In some demonstrative aspects, as shown in FIG. 3, optical-capability register structure 300 may include at least one register 306, which may be configured to include optical-capability (Cap.) information.

For example, the at least one register 306 may include optical-capability information 156 (FIG. 1).

In some demonstrative aspects, as shown in FIG. 3, optical-capability register structure 300 may include at least one register 308, which may be configured to include optical-training control information, for example, to configure optical-based link training procedure.

For example, the at least one register 308 may include OTC information 154 (FIG. 1).

In some demonstrative aspects, as shown in FIG. 3, optical-capability register structure 300 may include at least one register 310, which may be configured to include advertised information.

For example, the at least one register 310 may include advertised information 158 (FIG. 1).

In some demonstrative aspects, as shown in FIG. 3, optical-capability register structure 300 may include at least one register 312, which may be configured to include Link Training and Status State Machine (LTSSM) information.

In some demonstrative aspects, one or more, e.g., some or all, of the registers of optical-capability register structure 300 may configured according to an optical-capability register structure format, e.g., as follows:
Header: Capability Structure for optical
Optical Capability:
   “Bits [15:0]: Retimer related
   Bit 16: Redriver support 1:1
Data Rates supported by Optical: Read-Write (RW)”
   Bit [6:0]: Data rates 2.5 GT/s . . . 128.0 GT/s: Default: 00h . . . lowest speed must be the same across the Link; else behavior undefined
   Bit[16]: Strict Map supported
   Bit [17]: Flex map 1:1 supported
   Bits [15:7], [31:18]: Reserved
Optical Training Control: RW: Default 0000_0000h
   [15:0]: Training Time in msec (0−+25% accuracy)
   [19:16]: TS1/Scrambled/EIEOS frequency
      0000b: No EIEOS.
      0001b: EIEOS after every 32 TS1
      0010b: EIEOS after every 128 TS1
      0011b: EIEOS after every 1024 TS1
      Others: Mix of . . . Other mix of patterns
   20: Scrambled pattern (when 1b no TS1-only scrambled pattern, using scrambler at the available data rate-just TS1 headers are replaced with scrambler value and all payload of TS1 simply assumed to be 0)
   21: Train every data rate (when 1b train in every data rate; else only once)
   22: Optical needs its retraining at every data rate based on bits [20:0]
   23: Bypass Equalization
   24: Port in SRIS mode when 1b
   31: Start Training
Data Rates advertised by Link Partner: Read-only-sticky (ROS) [DRAL]
   Bit [6:0]: Data rates 2.5 GT/s, . . . 128 GT/s . . . default: 00h
   Bit [16]: Flex map 1:1 used
   Bit [17]:
LTSSM traversal: (since last exit from Detect) variable number of entries (x) that track the last x states—indicates state, amount of time

For example, the bit of the optical capability register 302 may include the redriver-support bit 157 (FIG. 1).

For example, the “data rates supported by optical” register 306 may include the optical-capability (Cap.) information 156 (FIG. 1).

For example, the bits [6:0] of the “data rates supported by optical” register 306 may include the supported data rate information 155 (FIG. 1).

For example, the bits [16:17] of the “data rates supported by optical” register 306 may include the mapping-capability information 159 (FIG. 1).

For example, the optical training control register 308 may include the OTC information 154 (FIG. 1).

For example, the bits [0:30] of the optical training control register 308 may include the OTC setting information 153 (FIG. 1).

For example, the bit of the optical training control register 308 may include the start-training bit 151 (FIG. 1).

For example, the “data rates advertised by link partner” register 310 may include the advertised information 158 (FIG. 1).

For example, the bits [6:0] of the “data rates advertised by link partner” register 310 may include the link partner data rate information, e.g., to indicate one or more data rates advertised by the partner electronic system 180 (FIG. 1), e.g., as described above.

For example, the bit of the “data rates advertised by link partner” register 310 may include the flexible-mapping bit, for example, to indicate use of a flexible mapping to map optical lanes of the redriver-based optical interconnect 170 (FIG. 1) to receiver electrical lanes at the electronic system 110 (FIG. 1), e.g., as described above.

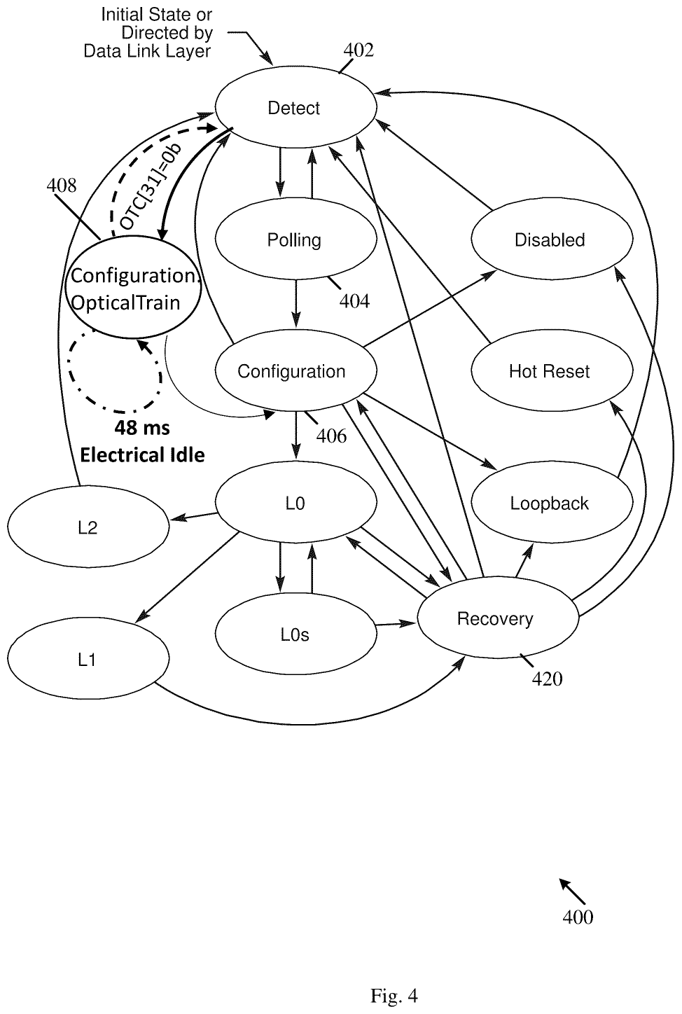

Reference is made to FIG. 4, which schematically illustrates an optical-based link training procedure 400, in accordance with some demonstrative aspects.

For example, PHY controller 130 (FIG. 1) may be configured to perform one or more operations and/or functionalities of the optical-based link training procedure 400.

In some demonstrative aspects, the optical-based link training procedure 400 may be implemented by an electronic system, e.g., electronic system 110 (FIG. 1), for example, to train a link via an electrical interconnect, e.g., electrical interconnect 163 (FIG. 1), between the electronic system and a partner electronic system, e.g., electronic system 180 (FIG. 1), for example, over a redriver-based optical interconnect, e.g., redriver-based optical interconnect 170 (FIG. 1), e.g., as described below.

In some demonstrative aspects, a detect state 402 the optical-based link training procedure 400 may be initiated, for example, based on a determination that a start-training bit, e.g., the start training bit 157 (FIG. 1), is set to “1”, e.g., as described below.

In some demonstrative aspects, as shown in FIG. 4, the optical-based link training procedure 400 may include a transition from detect state 402 to a polling state 404, e.g., as described below.

In some demonstrative aspects, the transition from detect state 402 to polling state 404 may be based, for example, on a determination that a lowest data rate of the electrical interconnect is included in one or more supported data rates for communication over the redriver-based optical interconnect, e.g., as described below.

In some demonstrative aspects, as shown in FIG. 4, the optical-based link training procedure 400 may include a transition from detect state 402 to a configuration optical training (Configuration.OpticalTrain) state 408, e.g., as described below.

In some demonstrative aspects, the transition from detect state 402 to the Configuration.OpticalTrain state 408 may be based, for example, on a determination that the lowest data rate of the electrical interconnect is not included in the one or more supported data rates for communication over the redriver-based optical interconnect, e.g., as described below.

In some demonstrative aspects, the Configuration.OpticalTrain state 408 may include an exchange of one or more training patterns between the electronic system and the partner electronic system, for example, according to one or more optical training control settings based on, e.g., defined by, associated with, corresponding to, and/or represented by, optical-training control information, e.g., as described below.

In some demonstrative aspects, as shown in FIG. 4, the optical-based link training procedure 400 may include a transition from the Configuration.OpticalTrain state 408 to a configuration state 406, e.g., as described below.

In some demonstrative aspects, as shown in FIG. 4, the optical-based link training procedure 400 may include a transition from the polling state 404 to a configuration state 406, e.g., as described below.

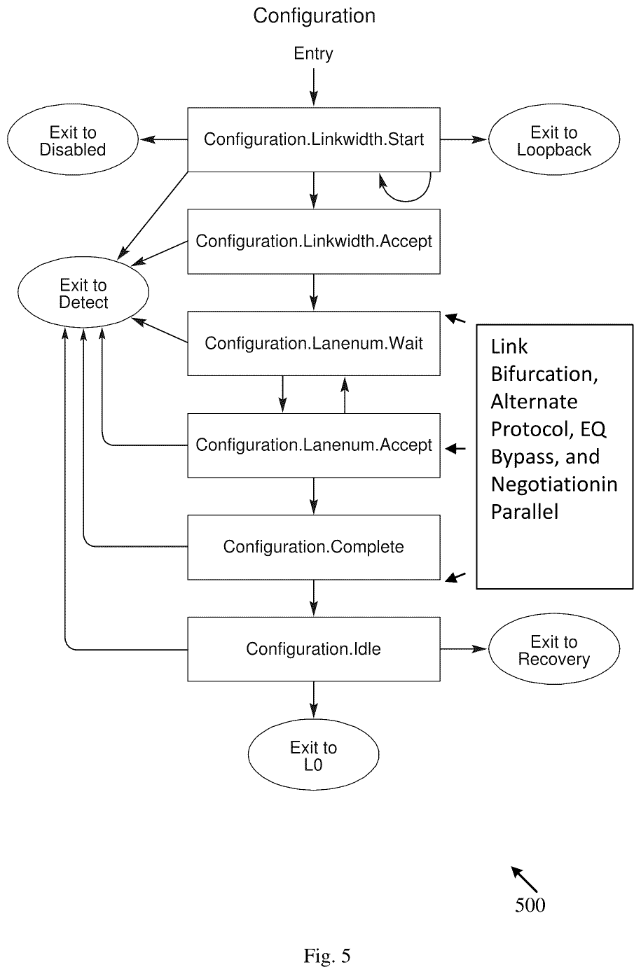

Reference is also made to FIG. 5, which illustrates a configuration state 500 of an optical-based link training procedure, in accordance with some demonstrative aspects.

For example, the configuration state 406 (FIG. 4) of the optical-based link training procedure 400 may be configured to include one or more operations and/or functionalities of the configuration state 500, e.g., as described below.

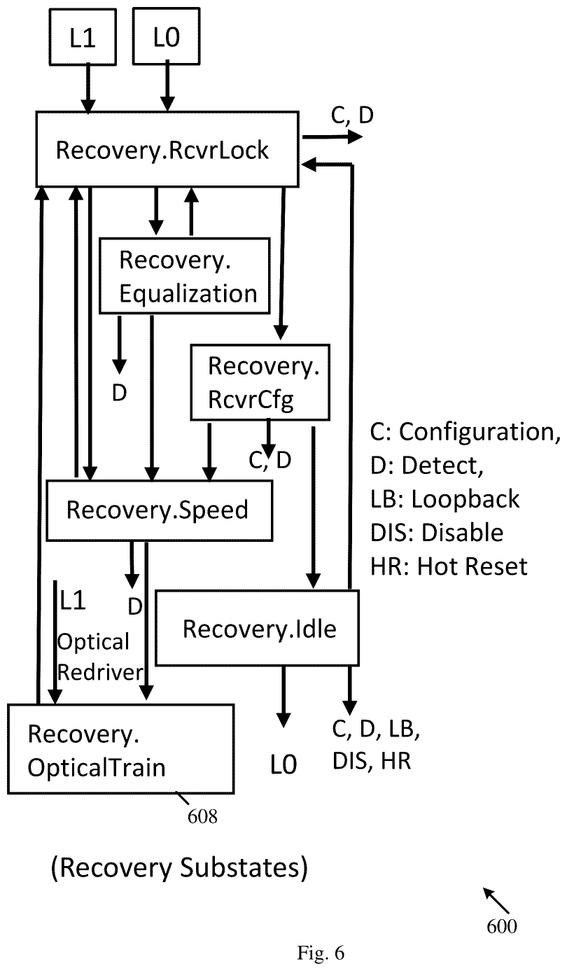

Reference is also made to FIG. 6, which illustrates a recovery state 600 of an optical-based link training procedure, in accordance with some demonstrative aspects.

For example, a recovery state 420 (FIG. 4) of the optical-based link training procedure 400 may be configured to include one or more operations and/or functionalities of the recovery state 600, e.g., as described below.

In some demonstrative aspects, the optical-based link training procedure 400 may be configured to include the Configuration.OpticalTrain state 408 (FIG. 4) and a recovery optical retraining (Recovery.OpticalRetrain) state 608 (FIG. 6), which may be configured to handle one or more, e.g., any, special optical redriver related requirements, for example, no support for a 2.5 GT/s data rate, and/or extra-training time, which may be required for optical components, e.g., as described below.

In some demonstrative aspects, the optical-based link training procedure 400 may be configured without L0 state support for an optical-based implementation. Accordingly, one or more bits, e.g., Number of Fast Training Sequences (NFTS) bits and/or one or more other bits, in the Training Sequence (TS), e.g., TS1/TS2, ordered sets may be used for optical training information purposes.

In some demonstrative aspects, the optical-based link training procedure 400 may be configured to support L1 and L2 states, e.g., as described below.

In some demonstrative aspects, the optical-based link training procedure 400 may be configured to support enhancements to the LTSSM, e.g., as described below.

In some demonstrative aspects, the optical-based link training procedure 400, the configuration state 500, and/or the recovery state 600 may be configured to implement one or more, e.g., some or all, of the following operations and/or functionalities:
Starting frequency decided by what optical supports
   ‘Data Rates supported by Optical’ (DRSO)—written from sideband/inband, e.g., prior to link training start, to indicate the data rates supported by optical.
Optical Training Control (OTC) register defines various parameters for the training.
All advertised supported data rates in TS1/TS2 are what the Port supports and advertised by the DRSO bits.
Update all state transitions in ‘LTSSM traversal’.
Link state transition:
   Detect.Quiet->Detect.Active on PERST removal and OTC.starttraining=1b. There is no Receiver Detect.
   Detect.Active->(change speed to the lowest data rate in DRSO when OTC.starttraining bit is set to 1b, reset LTSSM travel CSR)->
      if (DRSO [0]==0) Configuration.OpticalTrain; (change speed to the lowest data rate in DRSO)
      else (e.g., if DRSO [0]=1b (i.e., 2.5 GT/s is supported)) Polling.Active->Polling.Configuration->Configuration.Linkwidth.Start
Configuration.OpticalTrain:
   Send TS1/scrambled pattern/EIEOS, e.g., based on OTC-on TS1, set the “Optical Train” bit (for example, one of the reserved bits, e.g., current NFTS byte, can be used)
   Wait for “training time” (e.g., per OTC [15:0])-time-out timer starts counting then.
Timer (timeout counter) is reset if receiving TS1 with “optical train” bit set; Timeout in this state is 24 ms-on timeout wait for 48 ms and go back to Configuration.OpticalTrain.
   If receiving certain 0->1/1->0 transition (or 2-bit transitions in PAM-4) in >25% of bits over 1024 consecutive bits, move to Configuration.Linkwidth.Start
   All advertised supported data rates in TS1/TS2 are capped by the DRSO bits.
Configuration.Linkwidth.Start:
   Timer reset if two consecutive TS1'es with “Optical Train” bit is set to 1b
   If timeout, go back to Configuration.OpticalTrain—on the 5th timeout, change speed to the next higher data rate in DRSO.
   Follow the normal transition through rest of Configuration Substates to L0.
Configuration.Lanenum.Wait through Configuration.Complete: Link width, partitioning, alternate protocol negotiation happens as per current specification. Note down the supported Link Speeds by the Link partner in DRAL register (e.g., the highest link speed is the lower of the advertised data rates and received data rates).
   Update all relevant bits in LTSSM traversal
L0:
   Target data rate=min (max data rate in DRSO, max data rate in DRAL);
   enter_Rec_Opt=Target data rate>current data rate;
   Next_data_rate_opt=(OTC [21]==1b)? Target data rate: next supported data rate above current data rate;
   Enter Recovery.RcvrLock if enter_Rec_Opt=1b, e.g., if need to change the data rate;
   L0p: support is optional and negotiated using the same existing mechanism. Entry and exit to Electrical Idle is similar to entry/exit from L1 on the Lanes that are in Electrical idle, with the enhancements described here in the relevant LTSSM states for those Lanes (e.g., on exit from electrical idle, the Lane may enter Recovery.OpticalTrain) even though the Link is in L0 state.
Recovery: transition through the sub-states, e.g., as usual
   Recovery.Speed: set the LTSSM traversal register, change speed to Next_data_rate_opt and after the required minimum time in electrical idle, enter Recovery.OpticalTrain:
      If enter_Rec_Opt=1b; Else Recovery.RcvrLock
   Recovery.OpticalTrain: If OTC [22]=0b & transition not from L1/L2, go to Recovery.RcvrLock; else repeat the steps of Configuration.OpticalTrain but transition to Recovery.Rcvrlock (on timeout to Recovery.OpticalTrain)—Record each transition in LTSSM Traversal—on timeout change data rate to the data rate on which we entered Recovery from L0 and enter Recovery.RcvrLock
   On entry to Recovery.RcvrLock at Next_data_rate_opt, set Enter_Rec_Opt=0b
   Recovery.RcvrLock: On entry from Recovery.OpticalTrain, Reset timer if two consecutive TS1'es with “Optical Train” bit is set to 1b; note state transitions through Recovery to L0 in LTSSM traversal

Referring back to FIG. 1, in some demonstrative aspects, one or more Skip (SKP) Ordered Sets (OSs) may be implemented to map sideband signals, e.g., over sideband link 165, for example, instead of using a separate optical channel for sideband 165.

In some demonstrative aspects, the SKP Ordered Set bits for the sideband are set-up by the port, e.g., of electronic system 110. For example, the local port, e.g., of electronic system 110, may be configured to manage handshakes to the platform management 160, e.g., using the SKP OSs.

In some demonstrative aspects, as may be seen in Table 1 below, the link may be operated even without any sidebands, which can be dealt with locally. However, if a sideband does need to be used, a margin command field in an SKP OS (e.g., both with 128 b/130 b and 1 b/1 b) may be used, e.g., through the margin command register in the port, for example, to convey sideband when needed, e.g., as follows:
Sideband is sent as “Margin Payload [7:0]”. Margin Payload [7:0]={RSVD-6 bits, CLK REQ #, WAKE #}. The upper bits can be used for inter-port communication.
Set the Margin Type: 001b—Command, 010b—Ack with the values reflected back. A sideband signal is sent in consecutive SKP OSs till the peer sends back an Ack reflecting the exact sideband that was sent. A receiver checks for the CRC and at least two SKP OSs indicating the same sideband before reflecting the received sideband command locally.
The Fields: “Usage Model”=1b and Receiver Number=000b will be used for configuration access by the port. The proper Receiver Number and Usage Model-0 b can be used for config access as sideband. A set of registers can be defined as a mailbox to enable sideband access across the link. If the link is down, one optical channel can still be active that is only stuffed with P1s with periodic SKP OS.
If the link needs to operate in 8 b/10 b modem, two SKP OSs can be sent back to back and use the last two SKPs in the second SKP OS to communicate the sideband information as above.

The following Table 1 illustrates implementation of sideband signals in Card Electromechanical (CEM) specifications, which may outline the physical dimensions, connector types, and pin assignments required for a PCIe card to be compatible with motherboard slots. It ensures interoperability between different PCIe devices by defining the form factor and interface characteristics. In some aspects, only a subset of sideband signals may need to be sent across the optical interconnect 170.

TABLE 1

| Signal name (CEM) | Purpose | How is it handled in Optical? |
|---|---|---|
| RefClk−/RefClk+ | Reference Clock | No need to send across. |
| | | Locally used. SRIS mode only |
| PERST# | Main power is | Locally used. Optical |
| | with spec and | negotiation to indicate if the |
| | table | other side is ready to go (may |
| | | be send signals across)- if not, |
| | | don't get past Detect |
| WAKE# | Optional | Can send across as optical |
| | Reactivate | signals to indicate in SKP OS |
| | main power rails | |
| | and clocks | |
| SMBCLK/ | Optional | Local stuff - don't send |
| SMBDAT/JTAG | | across optical |
| PRSNT1#, | AIC presence | No need to send across - |
| PRSNT2# | detect pin | optical signal goes away/ |
| | | comes back indicating |
| | | ready to go |
| CLKREQ# | Optional | Can send optical signal in |
| | | SKP OS |
| PWRNRK#, MFG | Optional | Not sent across |

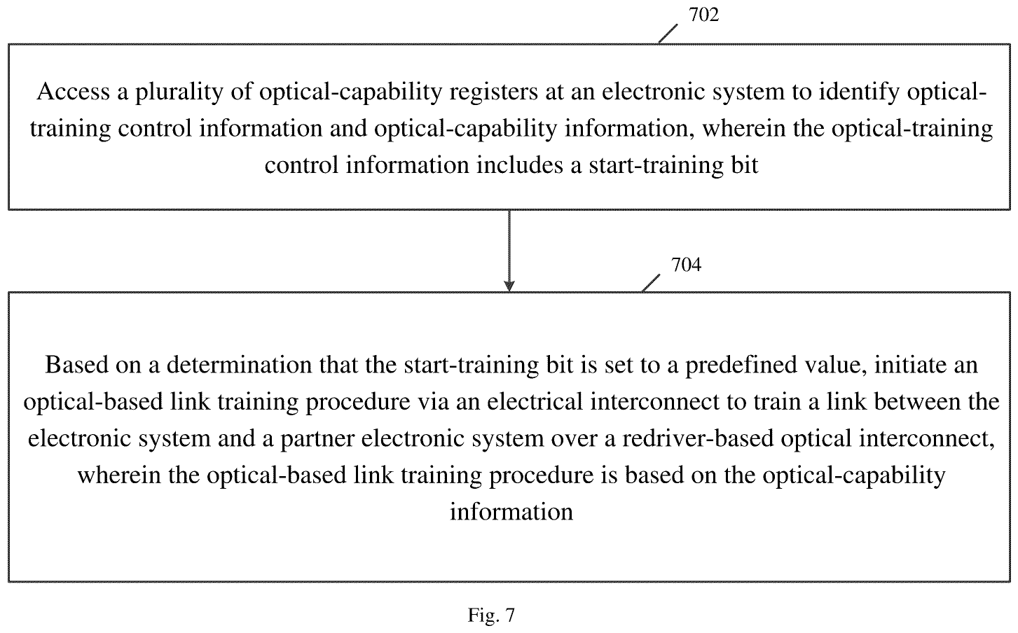

Reference is made to FIG. 7, which schematically illustrates a method of link training over a redriver-based optical interconnect, in accordance with some demonstrative aspects. For example, one or more of the operations of the method of FIG. 7 may be performed by one or more elements of a system, e.g., system 100 (FIG. 1), for example, one or more electronic systems, e.g., electronic system 110 (FIG. 1), and/or electronic system 180 (FIG. 1), and/or a PHY controller, e.g., PHY controller 130 (FIG. 1).

As indicated at block 702, the method may include accessing a plurality of optical-capability registers at an electronic system to identify optical-training control information and optical-capability information. For example, the optical-training control information may include a start-training bit. For example, PHY controller 130 (FIG. 1) may be configured to access the plurality of optical-capability registers 152 (FIG. 1) to identify the optical-training control information 154, e.g., including the start-training bit 151 (FIG. 1), and the optical-capability information 156 (FIG. 1), e.g., as described above.

As indicated at block 704, the method may include initiating an optical-based link training procedure via an electrical interconnect to train a link between the electronic system and a partner electronic system over a redriver-based optical interconnect, for example, based on a determination that the start-training bit is set to a predefined value. For example, the optical-based link training procedure may be based on the optical-capability information. For example, PHY controller 130 (FIG. 1) may be configured to initiate the optical-based link training procedure 400 (FIG. 4) via the electrical interconnect 163 (FIG. 1) to train a link between the electronic system 110 (FIG. 1) and the partner electronic system 180 (FIG. 1) over the redriver-based optical interconnect 170 (FIG. 1), for example, based on a determination that the start-training bit 151 (FIG. 1), is set to “1”, e.g., as described above.

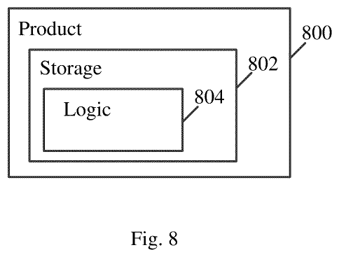

Reference is made to FIG. 8, which schematically illustrates a product of manufacture 800, in accordance with some demonstrative aspects. Product 800 may include one or more tangible computer-readable (“machine-readable”) non-transitory storage media 802, which may include instructions, e.g., implemented by logic 804, operable to, when executed by at least one processor, enable the at least one processor to perform, trigger and/or implement one or more operations and/or functionalities described with reference to the FIGS. 1-7, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 800 and/or machine readable storage media 802 may include one or more types of computer-readable storage media capable of storing data, including volatile memory, non-volatile memory, removable or non-removable memory, erasable or non-erasable memory, writeable or re-writeable memory, and the like. For example, machine readable storage media 802 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 804 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 804 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### Examples

The following examples pertain to further aspects.

Example 1 includes an apparatus comprising an electronic system, e.g., a System on Chip (SoC) a System in Package (SiP), or the like, comprising interconnect circuitry to communicate over an electrical interconnect; and a Physical layer (PHY) controller configured to access a plurality of optical-capability registers to identify optical-training control information and optical-capability information, wherein the optical-training control information comprises a start-training bit; and based on a determination that the start-training bit is set to a predefined value, initiate an optical-based link training procedure via the electrical interconnect to train a link between the electronic system, e.g., SoC, SiP or the like, and a partner electronic system over a redriver-based optical interconnect, wherein the optical-based link training procedure is based on the optical-capability information.

Example 2 includes the subject matter of Example 1, and optionally, wherein the optical-capability information comprises supported data rate information to indicate one or more supported data rates for communication over the redriver-based optical interconnect, wherein the optical-based link training procedure is based on the supported data rate information.

Example 3 includes the subject matter of Example 2, and optionally, wherein the PHY controller is configured to transition from a detect state of the optical-based link training procedure to a configuration optical training (Configuration.OpticalTrain) state of the optical-based link training procedure based on a determination that a lowest data rate of the electrical interconnect is not included in the one or more supported data rates for communication over the redriver-based optical interconnect, wherein the Configuration.OpticalTrain state comprises an exchange of one or more training patterns between the electronic system, e.g., SoC, SiP or the like, and the partner electronic system according to one or more optical training control settings based on, e.g., defined by, associated with, corresponding to, and/or represented by, the optical-training control information.

Example 4 includes the subject matter of Example 2 or 3, and optionally, wherein the PHY controller is configured to transition from a detect state of the optical-based link training procedure to a polling state based on a determination that a lowest data rate of the electrical interconnect is included in the one or more supported data rates for communication over the redriver-based optical interconnect.

Example 5 includes the subject matter of any one of Examples 2-4, and optionally, wherein the PHY controller is configured to set a target data rate for the link based on a first maximal data rate and a second maximal data rate, the first maximal data rate comprises a maximal data rate of the one or more supported data rates according to the supported data rate information, the second maximal data rate comprises a maximal data rate supported by the partner electronic system.

Example 6 includes the subject matter of Example 5, and optionally, wherein the PHY controller is configured to initiate a recovery optical training (Recovery.Optical.Train) state to train the target data rate, based on a determination that the target data rate is greater than a currently trained data rate.

Example 7 includes the subject matter of Example 5 or 6, and optionally, wherein the PHY controller is configured to identify that a next data rate higher than a current data rate is to be trained based on a determination that the optical-training control information indicates a requirement to train every data rate, wherein the PHY controller is configured to initiate a recovery optical training (Recovery.Optical.Train) state to train the next data rate.

Example 8 includes the subject matter of any one of Examples 5-7, and optionally, wherein the PHY controller is configured to set the target data rate for the link based on a lowest one of the first maximal data rate and the second maximal data rate.

Example 9 includes the subject matter of any one of Examples 2-8, and optionally, wherein the supported data rate information comprises a plurality of data-rate bits corresponding to a respective plurality of data rates, wherein a setting of a data-rate bit to “1” is to indicate that a data rate corresponding to the data-rate bit is supported.

Example 10 includes the subject matter of Example 9, and optionally, wherein the plurality of data-rate bits comprises 7 bits.

Example 11 includes the subject matter of any one of Examples 1-10, and optionally, wherein the PHY controller is configured to, at a configuration optical training (Configuration.OpticalTrain) state of the optical-based link training procedure, exchange one or more training patterns between the electronic system, e.g., SoC, SiP or the like, and the partner electronic system according to one or more optical training control settings based on, e.g., defined by, associated with, corresponding to, and/or represented by, the optical-training control information.

Example 12 includes the subject matter of Example 11, and optionally, wherein the PHY controller is configured to determine a training time period corresponding to the electronic system, e.g., SoC, SiP or the like, based on the optical-training control information, and to wait the training time period after sending a training pattern to the partner electronic system via the electrical interconnect.

Example 13 includes the subject matter of Example 11 or 12, and optionally, wherein the PHY controller is configured to, at the Configuration.OpticalTrain state send a training pattern to the partner electronic system via the electrical interconnect; wait for a training time period corresponding to the electronic system, e.g., SoC, SiP or the like, after sending the training pattern, the one or more optical training control settings comprising the training time period corresponding to the electronic system, e.g., SoC, SiP or the like; start a timeout counter after the training time period corresponding to the electronic system, e.g., SoC, SiP or the like; wait for a predefined time period based on expiration of the timeout counter; and send the training pattern after the predefined time period.

Example 14 includes the subject matter of Example 13, and optionally, wherein the PHY controller is configured to reset the timeout counter based on receipt of a training pattern from the partner electronic system comprising an optical-training bit set to a predefined value.

Example 15 includes the subject matter of Example 14, and optionally, wherein the predefined value of the optical-training bit is to indicate that the partner electronic system has not yet reached a training time corresponding to the partner electronic system.

Example 16 includes the subject matter of any one of Examples 13-15, and optionally, wherein the timeout counter is to count a timeout period of a first duration, wherein the predefined time period has a second duration longer than the first duration.

Example 17 includes the subject matter of any one of Examples 13-16, and optionally, wherein the timeout counter is to count a timeout period of 24 milliseconds, and the predefined time period is 48 milliseconds.

Example 18 includes the subject matter of any one of Examples 11-17, and optionally, wherein the PHY controller is configured to switch from the Configuration.OpticalTrain state to a configuration link-width start (Configuration.LinkWidth.Start) state based on a determination that a predefined bit transition criterion is met with respect to training pattern bits received from the partner electronic system.

Example 19 includes the subject matter of Example 18, and optionally, wherein the PHY controller is configured to, at the Configuration.LinkWidth.Start state reset a timer of a predefined timeout period based on receipt of two consecutive training patterns from the partner electronic system, which comprise an optical-training bit set to a predefined value; and switch back from the Configuration.LinkWidth.Start state to the Configuration.OpticalTrain state based on expiration of the timer of the predefined timeout period.

Example 20 includes the subject matter of Example 19, and optionally, wherein the PHY controller is configured to switch from a current data rate to a next higher supported data rate when switching back from the Configuration.LinkWidth.Start state to the Configuration.OpticalTrain state based on a determination that the timer of the predefined timeout period has expired for a predefined number of times.

Example 21 includes the subject matter of Example 20, and optionally, wherein the predefined number of times is 5.

Example 22 includes the subject matter of any one of Examples 19-21, and optionally, wherein the predefined value of the optical-training bit is to indicate that the partner electronic system has not yet reached a training time corresponding to the partner electronic system.

Example 23 includes the subject matter of any one of Examples 1-22, and optionally, wherein the optical-capability information comprises mapping-capability information to indicate at least one supported type of bit-mapping between the electric interconnect and the redriver-based optical interconnect.

Example 24 includes the subject matter of Example 23, and optionally, wherein the mapping-capability information comprises a strict-mapping bit and a flexible-mapping bit, the strict-mapping bit to indicate whether a strict mapping between electrical lanes and optical lanes is supported, the flexible-mapping bit to indicate whether a flexible mapping between electrical lanes and optical lanes is supported.

Example 25 includes the subject matter of any one of Examples 1-24, and optionally, wherein the PHY controller is configured to identify one or more optical training control settings based on the optical-training control information, and to control the optical-based link training procedure based on the one or more optical training control settings.

Example 26 includes the subject matter of Example 25, and optionally, wherein the optical training control information comprises training time information to indicate a training time period corresponding to the electronic system, e.g., SoC, SiP or the like, in microseconds, wherein the PHY controller is configured to wait for the training time period corresponding to the electronic system, e.g., SoC, SiP or the like, after sending a training pattern and before counting a timeout counter for receipt of a training pattern from the partner electronic system.

Example 27 includes the subject matter of Example 25 or 26, and optionally, wherein the optical training control information comprises pattern type information to indicate a training pattern type, wherein the PHY controller is configured to transmit a training pattern according to the training pattern type during the optical-based link training procedure.

Example 28 includes the subject matter of any one of Examples 25-27, and optionally, wherein the optical training control information comprises a train-every-data-rate bit to indicate whether every data rate is to be trained during the optical-based link training procedure.

Example 29 includes the subject matter of any one of Examples 1-28, and optionally, wherein the PHY controller is configured to set a redriver-support bit in the optical-capability registers to a predefined value to indicate that the PHY controller supports communication over the redriver-based optical interconnect.

Example 30 includes the subject matter of any one of Examples 1-29, and optionally, wherein the PHY controller is configured to set link partner data rate information in the optical-capability registers, the link partner data rate information to indicate one or more data rates advertised by the partner electronic system.

Example 31 includes the subject matter of any one of Examples 1-30, and optionally, wherein the PHY controller is configured to set a flexible-mapping bit in the optical-capability registers to indicate use of a flexible mapping to map optical lanes of the redriver-based optical interconnect to receiver electrical lanes at the electronic system, e.g., SoC, SiP or the like.

Example 32 includes the subject matter of any one of Examples 1-31, and optionally, wherein the predefined value of the start-training bit is 1.

Example 33 includes the subject matter of any one of Examples 1-32, and optionally, wherein the PHY controller is configured to access a first 32-bit register of the plurality of optical-capability registers to identify the optical-capability information, and access a second 32-bit register of the plurality of optical-capability registers to identify the optical-training control information.

Example 34 includes the subject matter of any one of Examples 1-33, and optionally, wherein the electrical interconnect comprises a Peripheral Component Interconnect Express (PCIe) interconnect, the link comprises a PCIe link.

Example 35 includes the subject matter of any one of Examples 1-34, and optionally, wherein the electrical interconnect comprises a Compute Express Link (CXL) interconnect, the link comprises a CXL link.

Example 36 includes a system comprising a first electronic system, e.g., SoC, SiP or the like; a second electronic system, e.g., SoC, SiP or the like; and a combined interconnect to interconnect between the first electronic system and the second electronic system, the combined interconnect comprising an electrical interconnect and a redriver-based optical interconnect, wherein at least one SoC of the first electronic system and/or the second electronic system comprises interconnect circuitry to communicate over the electrical interconnect; and a Physical layer (PHY) controller configured to access a plurality of optical-capability registers to identify optical-training control information and optical-capability information, wherein the optical-training control information comprises a start-training bit; and based on a determination that the start-training bit is set to a predefined value, initiate an optical-based link training procedure via the electrical interconnect to train a link between the first electronic system and the second electronic system over the redriver-based optical interconnect, wherein the optical-based link training procedure is based on the optical-capability information.

Example 37 includes the subject matter of Example 36 and optionally, comprising the subject matter of any of Examples 1-35.

Example 38 includes a System on Chip (SoC) comprising the subject matter of any of Examples 1-35.

Example 39 includes a System in Package (SiP) comprising the subject matter of any of Examples 1-35.

Example 40 includes a package comprising the subject matter of any of Examples 1-35.

Example 41 includes a computing device comprising the subject matter of any of Examples 1-35.

Example 42 includes a computing system comprising the subject matter of any of Examples 1-35.

Example 43 comprises a mobile device comprising the subject matter of any of Examples 1-35.

Example 44 comprises a server device comprising the subject matter of any of Examples 1-35.

Example 45 comprises an apparatus comprising means for executing any of the described operations of Examples 1-35.

Example 46 comprises a product comprising one or more tangible computer-readable non-transitory storage media comprising instructions operable to, when executed by at least one processor, enable the at least one processor to cause a device to perform any of the described operations of Examples 1-35.

Example 47 comprises an apparatus comprising: a memory interface; and processing circuitry configured to: perform any of the described operations of Examples 1-35.

Example 48 comprises a method comprising any of the described operations of Examples 1-35.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising:
an electronic system comprising:
interconnect circuitry to communicate over an electrical interconnect; and
a Physical layer (PHY) controller configured to:
access a plurality of optical-capability registers to identify optical-training control information and optical-capability information, wherein the optical-training control information comprises a start-training bit; and
based on a determination that the start-training bit is set to a predefined value, initiate an optical-based link training procedure via the electrical interconnect to train a link between the electronic system and a partner electronic system over a redriver-based optical interconnect, wherein the optical-based link training procedure is based on the optical-capability information.

2. The apparatus of claim 1, wherein the optical-capability information comprises supported data rate information to indicate one or more supported data rates for communication over the redriver-based optical interconnect, wherein the optical-based link training procedure is based on the supported data rate information.

3. The apparatus of claim 2, wherein the PHY controller is configured to transition from a detect state of the optical-based link training procedure to a configuration optical training state of the optical-based link training procedure based on a determination that a lowest data rate of the electrical interconnect is not included in the one or more supported data rates for communication over the redriver-based optical interconnect, wherein the configuration optical training state comprises an exchange of one or more training patterns between the electronic system and the partner electronic system according to one or more optical training control settings based on the optical-training control information.

4. The apparatus of claim 2, wherein the PHY controller is configured to transition from a detect state of the optical-based link training procedure to a polling state based on a determination that a lowest data rate of the electrical interconnect is included in the one or more supported data rates for communication over the redriver-based optical interconnect.

5. The apparatus of claim 2, wherein the PHY controller is configured to set a target data rate for the link based on a first maximal data rate and a second maximal data rate, the first maximal data rate comprises a maximal data rate of the one or more supported data rates according to the supported data rate information, the second maximal data rate comprises a maximal data rate supported by the partner electronic system.

6. The apparatus of claim 5, wherein the PHY controller is configured to initiate a recovery optical training state to train the target data rate, based on a determination that the target data rate is greater than a currently trained data rate.

7. The apparatus of claim 1, wherein the PHY controller is configured to, at a configuration optical training state of the optical-based link training procedure, exchange one or more training patterns between the electronic system and the partner electronic system according to one or more optical training control settings based on the optical-training control information.

8. The apparatus of claim 7, wherein the PHY controller is configured to determine a training time period corresponding to the electronic system based on the optical-training control information, and to wait the training time period after sending a training pattern to the partner electronic system via the electrical interconnect.

9. The apparatus of claim 7, wherein the PHY controller is configured to, at the configuration optical training state:
send a training pattern to the partner electronic system via the electrical interconnect;
wait for a training time period corresponding to the electronic system after sending the training pattern, the one or more optical training control settings comprising the training time period corresponding to the electronic system;
start a timeout counter after the training time period corresponding to the electronic system;
wait for a predefined time period based on expiration of the timeout counter; and
send the training pattern after the predefined time period.

10. The apparatus of claim 9, wherein the PHY controller is configured to reset the timeout counter based on receipt of a training pattern from the partner electronic system comprising an optical-training bit set to a predefined value.

11. The apparatus of claim 7, wherein the PHY controller is configured to switch from the configuration optical training state to a configuration link-width start state based on a determination that a predefined bit transition criterion is met with respect to training pattern bits received from the partner electronic system.

12. The apparatus of claim 11, wherein the PHY controller is configured to, at the configuration link-width start state:
reset a timer of a predefined timeout period based on receipt of two consecutive training patterns from the partner electronic system, which comprise an optical-training bit set to a predefined value; and
switch back from the configuration link-width start state to the configuration optical training state based on expiration of the timer of the predefined timeout period.

13. The apparatus of claim 1, wherein the optical-capability information comprises mapping-capability information to indicate at least one supported type of bit-mapping between the electric interconnect and the redriver-based optical interconnect.

14. The apparatus of claim 13, wherein the mapping-capability information comprises a strict-mapping bit and a flexible-mapping bit, the strict-mapping bit to indicate whether a strict mapping between electrical lanes and optical lanes is supported, the flexible-mapping bit to indicate whether a flexible mapping between electrical lanes and optical lanes is supported.

15. The apparatus of claim 1, wherein the PHY controller is configured to identify one or more optical training control settings based on the optical-training control information, and to control the optical-based link training procedure based on the one or more optical training control settings.

16. The apparatus of claim 15, wherein the optical training control information comprises training time information to indicate a training time period corresponding to the electronic system in microseconds, wherein the PHY controller is configured to wait for the training time period corresponding to the electronic system after sending a training pattern and before counting a timeout counter for receipt of a training pattern from the partner electronic system.

17. The apparatus of claim 15, wherein the optical training control information comprises pattern type information to indicate a training pattern type, wherein the PHY controller is configured to transmit a training pattern according to the training pattern type during the optical-based link training procedure.

18. The apparatus of claim 1, wherein the PHY controller is configured to set a redriver-support bit in the optical-capability registers to a predefined value to indicate that the PHY controller supports communication over the redriver-based optical interconnect.

19. A system comprising:
a first electronic system;
a second electronic system; and
a combined interconnect to interconnect between the first electronic system and the second electronic system, the combined interconnect comprising an electrical interconnect and a redriver-based optical interconnect,
wherein the first electronic system comprises:
interconnect circuitry to communicate over the electrical interconnect; and
a Physical layer (PHY) controller configured to:
access a plurality of optical-capability registers to identify optical-training control information and optical-capability information, wherein the optical-training control information comprises a start-training bit; and
based on a determination that the start-training bit is set to a predefined value, initiate an optical-based link training procedure via the electrical interconnect to train a link between the first electronic system and the second electronic system over the redriver-based optical interconnect, wherein the optical-based link training procedure is based on the optical-capability information.

20. The system of claim 19, wherein the optical-capability information comprises mapping-capability information to indicate at least one supported type of bit-mapping between the electric interconnect and the redriver-based optical interconnect.
